(19) United States
(12) Patent Application Publication
(10) Pub. No.: US 2015/0367970 A1
(43) Pub. Date: Dec. 24, 2015

(54) PILL PACKAGING

(71) Applicant: ADVANTAGE PHARMACY SERVICES LLC, Madison, MS (US)

(72) Inventors: John Todd Barrett, Madison, MS (US); Fred P. Schoville, Brighton, MI (US); Mark Kucera, Howell, MI (US)

(21) Appl. No.: 14/652,192

(22) PCT Filed: Jan. 14, 2014
(86) PCT No.: PCT/US14/11381

§ 371 Date: Jun. 15, 2015

Related U.S. Application Data
(60) Provisional application No. 61/752,497, filed on Jan. 15, 2013.

(51) Int. Cl. B65B 9/04; B65D 65/40; A61J 1/03

(52) U.S. Cl. CPC B65B 9/045; A61J 1/03; B65D 65/40

(57) ABSTRACT

A pill packaging machine and a method of packaging pills. The method includes supplying first and second sheets of flaccid packaging material, rolling the first and second sheets into spaced apart opposed relation and into contact with one another, guiding pills along a guide path toward an ejection path having an ejection outlet that is spaced apart from a line of contact between the first and second sheets, spinning a resiliently deformable ejection roller into frictional contact with the pills to eject the pills through the ejection path out of the ejection outlet to a location between the first and second sheets, and further rolling the first and second sheets to enclose the pills therebetween.

### TECHNICAL FIELD

The field to which the disclosure generally relates includes packaging of pills and, more specifically, pill packaging in a continuous strip of laminate sheet pill packages.

### BACKGROUND

Methods and apparatus for packaging pills in continuous strips of laminate sheet pill packages has been well known for decades. But such processes and related equipment operate in an intermittent, stop-and-go manner, typically produce only about one to two packets per second, and/or damage pills.

### SUMMARY

According to one aspect of the present disclosure, a pill packaging machine includes first and second spindles to carry coils of first and second sheets of flaccid packaging material, and first and second package rollers to feed the first and second sheets into spaced apart opposed relation to one another, wherein the package rollers have rotational axes. The machine also includes a pill guide including an upstream end, a downstream end located between the rotational axes of the package rollers and spaced upstream from a line of contact between the first and second sheets, a guide path between the upstream and downstream ends, and an ejection path having an ejection outlet at the downstream end of the pill guide. The machine further includes an ejector oriented between the guide and ejection paths to eject the pills at a controlled velocity in excess of that provided by gravity free fall alone and including a resiliently deformable ejection roller having an outer diameter to frictionally contact the pills and eject the pills through the ejection path out of the ejection outlet to a location between the first and second sheets.

According to another aspect of the present disclosure, a method of packaging pills includes the following steps:
supplying first and second sheets of flaccid packaging material;
rolling the first and second sheets into spaced apart opposed relation and into contact with one another;
guiding pills along a guide path toward an ejection path having an ejection outlet that is spaced apart from a line of contact between the first and second sheets;
spinning a resiliently deformable ejection roller into frictional contact with the pills to eject the pills through the ejection path out of the ejection outlet to a location between the first and second sheets; and
further rolling the first and second sheets to enclose the pills therebetween.

### BRIEF DESCRIPTION OF THE DRAWINGS

Illustrative embodiments of pill packaging will become more fully understood from the detailed description and the accompanying drawings, wherein:

FIG. 1 is a front elevational view of an illustrative embodiment of a pill packaging apparatus;

FIG. 2 is an enlarged, fragmentary, top and side perspective view of the pill packaging apparatus of FIG. 1;

FIG. 3 is an enlarged, fragmentary, front elevational view of the pill packaging apparatus of FIG. 1, illustrating ejection and roller portions of the apparatus;

FIG. 4 is an enlarged, fragmentary, front elevational view of the ejection portion of the apparatus;

FIG. 5 is an enlarged, fragmentary, top perspective view of a downstream portion of a guide path and of the ejection portion of the apparatus;

FIG. 6 is an enlarged, fragmentary, top and side perspective view of the ejection and roller portions of the pill packaging apparatus;

FIG. 7 is an enlarged, fragmentary, top view of a portion of the pill packaging apparatus of FIG. 1;

FIG. 8 is an enlarged, fragmentary, rear elevational view of the pill packaging apparatus of FIG. 1, illustrating a rear of a drivetrain of the roller portion of the apparatus;

FIG. 9 is a block diagram of a packaging machine computer and other machine elements;

FIG. 10 is a side view of a strip of pill packages; and

FIG. 11 is a top view of side-by-sides strips of pill packages.

### DETAILED DESCRIPTION OF ILLUSTRATIVE EMBODIMENTS

The following description of the embodiment(s) is merely illustrative in nature and is in no way intended to limit the invention, its application, or uses.

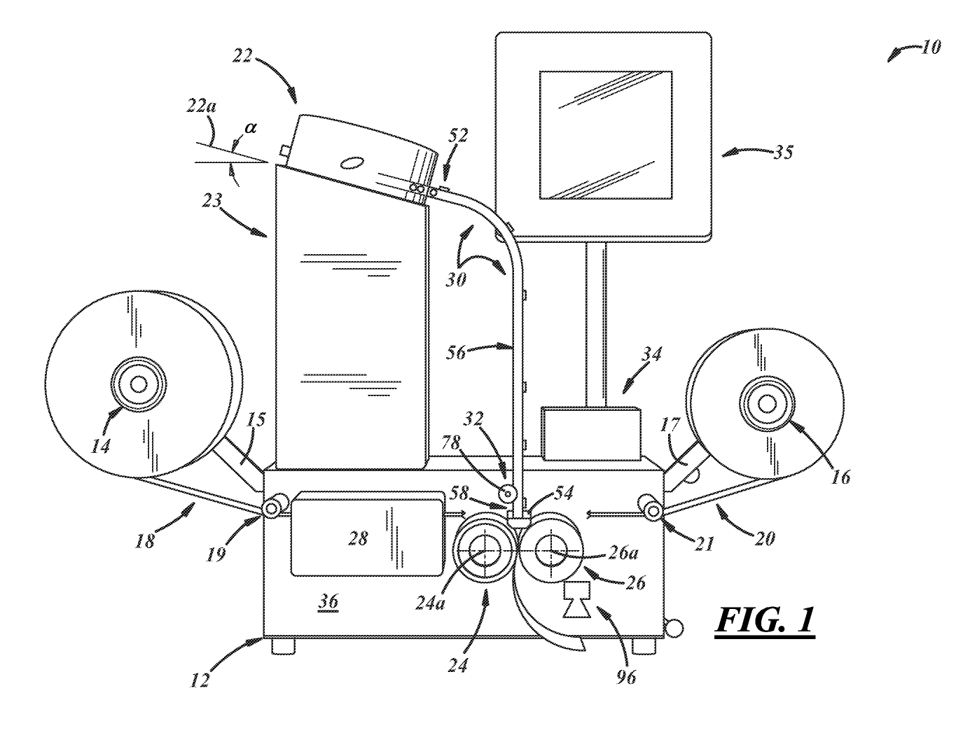

FIG. 1 illustrates a pill packaging machine 10 that can be used to package pills. The machine may include a machine support 12 of any suitable type to support other elements of the machine 10, first and second spindles 14, 16 to carry first and second strips 18, 20 of cover materials, and a pill feeder 22 that may be supported on a feeder support 23 that may be carried by the machine support 12 to hold and feed pills. The machine 10 also may include first and second package rollers 24, 26 that may be supported by the machine support 12 to roll the strips 18, 20 of cover materials together, and a printer 28 that may be supported by the machine support 12 to print indicia on cover material. The machine 10 further may include a pill guide 30 that may be coupled to the pill feeder 22 and supported by the machine support 12 to guide pills from the pill feeder 22 toward the package rollers 24, 26, a pill ejector 32 to eject pills from the pill guide 30 to a location between the package rollers 24, 26, and a packaging machine computer 34 including a user interface 35.

The machine and/or feeder supports 12, 23 may include any suitable structure(s) to support the pill feeder 22 and the other machine elements. The supports 12, 23 may be constructed of plate weldments, and/or one or more frames with cover plates, or of any other suitable support structure(s).

The first and second spindles 14, 16 may carry coils of the first and second sheets 18, 20 of cover materials, which may include flaccid packaging materials of any suitable type. The spindles 14, 16 may be coupled to the machine support 12 by arms 15, 17 or may be supported in any other suitable manner. The first spindle 14 may carry a first coil of cover material, which may include foil and, more specifically, may include a laminate of foil and paper. The foil may include a metallic and/or polymeric foil, and the paper may be printable paper, for instance direct thermal paper for thermal printing or laser paper for laser printing. The second spindle 16 may carry a second coil of cover material, which may include a polymeric material, which may include cellophane, polyurethane, polyvinylchloride, or any other material that may be heat sealable to the first sheet 18 of cover material. The materials may be provided in any suitable thicknesses. For example, the first cover material may be about 0.007″ in thickness, and the second cover material may be about 0.004″ in thickness.

The pill feeder 22 may include a vibratory and/or centrifugal bowl feeder and motor. For example, the bowl feeder may include a flat disc or an inverted cone that may rotate between 60 and 600 RPM or at any other suitable speed. The bowl feeder may carry about 2500 pills or any other suitable quantity depending on the pill size and other application parameters. In any event, the pill feeder 22 may output ten to twenty pills per second.

An operational or output axis 22a of the pill feeder 22 may be disposed at an angle α of greater than one degree with respect to level ground and/or to an axis 25 running through center lines 24a, 26a of the package rollers 24a, 26a. Preferably, the angle α may be about fifteen degrees, for example, from ten to twenty degrees. The angle α may ensure that the pill feeder 22 is able to output pills at a rate that can keep up with the rate of ejection of the pills out of the pill guide 30.

The first and second package rollers 24, 26 feed the first and second sheets 18, 20 into spaced apart opposed relation to one another. The first and second package rollers 24, 26 may be rotatably supported by the machine support 12 in any suitable manner.

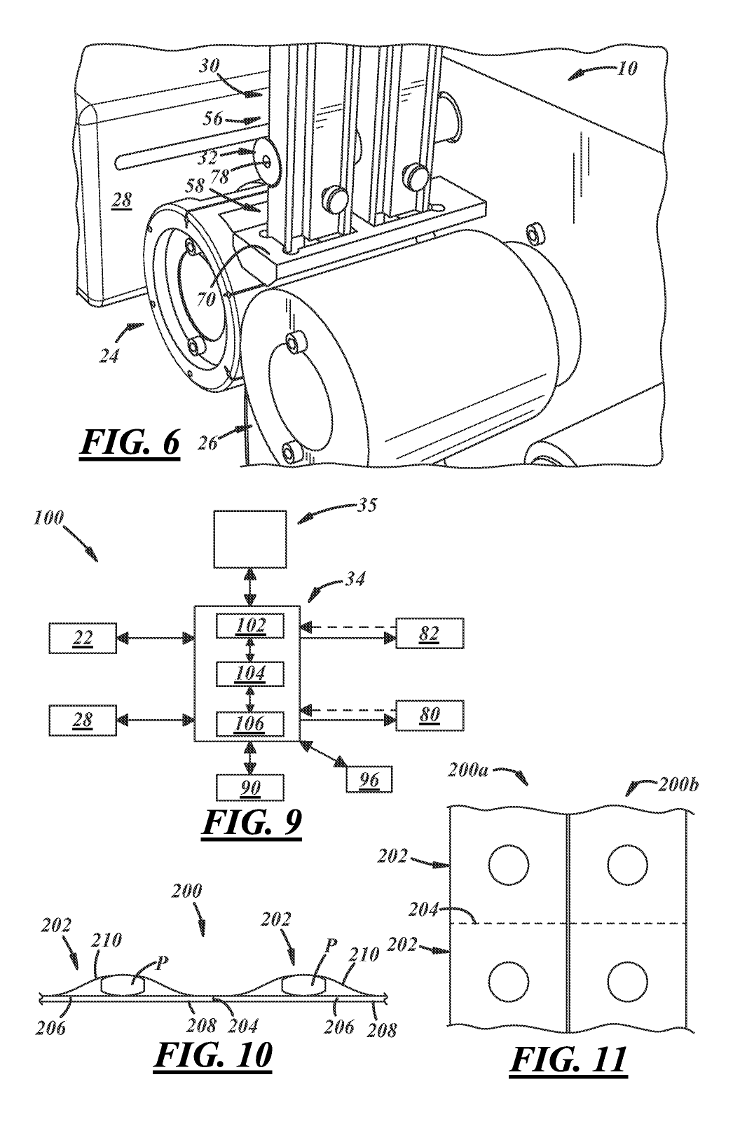

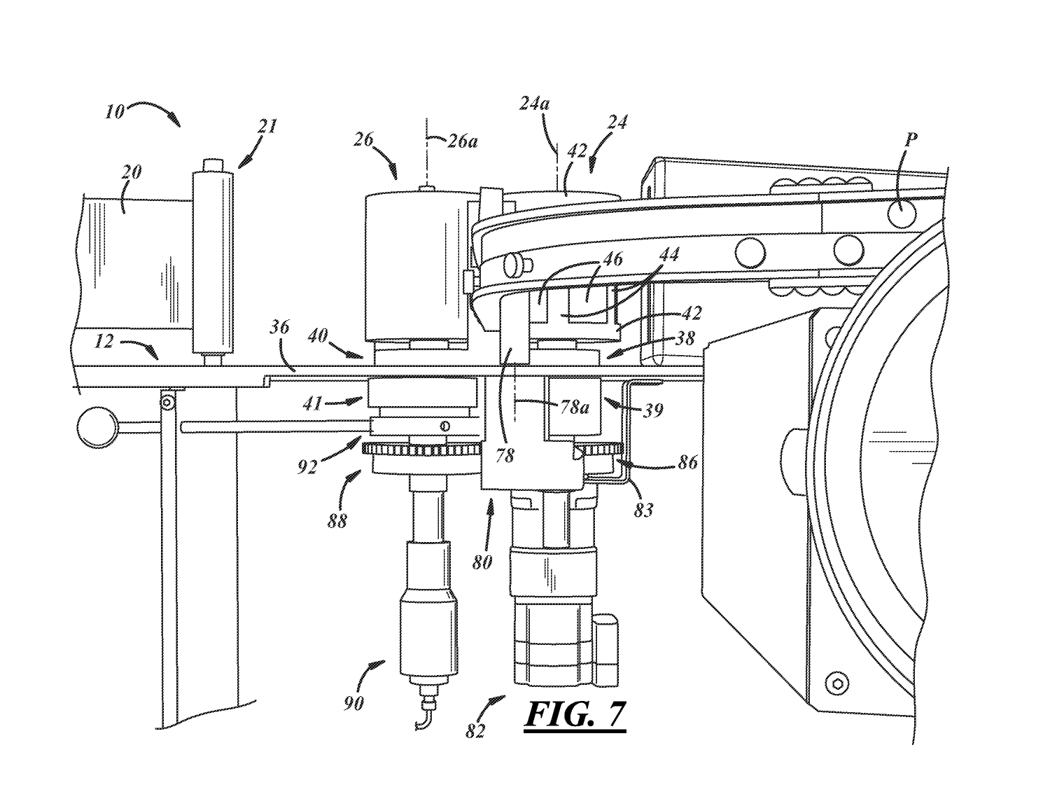

For example, with reference to FIG. 7, the package rollers 24, 26 may be coupled to a support member 36 of the machine support 12 via one or more bearing supports 38, 39 and 40, 41 that may be fastened or otherwise coupled to either side of the support member 36. The first roller 24 may include axial and circumferential portions 42, 44 that at least partially define outer circumferential surfaces of the roller 24, and pockets 46 therebetween to provide space for pills being packaged. The circumferential portions 44, 46 may extend over a circumferential distance that may correspond to an individual package length of about 1″ to 2″. The first roller 24 also may include perforators 48 extending along the axial portions 42 to perforate one or both of the cover materials, and a circumferentially extending roller knife 50 to define two separate packaging strips. The second roller 26 may include a thermal roller to heat seal the cover materials together, for example, in correspondence with the axial and circumferential portions 42, 44 of the first roller 24. The heated roller 26 may include a high temperature urethane.

Referring again to FIG. 1, the printer 28 may be coupled to the support member 36 in any suitable manner, and may be used to print any desired indicia on the first sheet 18 of cover material. Such printers are well known to those of ordinary skill in the art.

The pill guide 30 includes an upstream end 52 in communication with an outlet of the pill feeder 22, and a downstream end 54 located between the rotational axes 24a, 26a of the package rollers 24, 26 and spaced upstream from a line of contact between the first and second sheets 18, 20 of cover material. Those of ordinary skill in the art would recognize that the line of contact is at or slightly above a roller axis 25 extending between the rotational axes 24a, 26a of the package rollers 24, 26. The outside diameters of the rollers 24, 26 may be spaced apart about 0.012″ to 0.015″ or any other suitable distance.

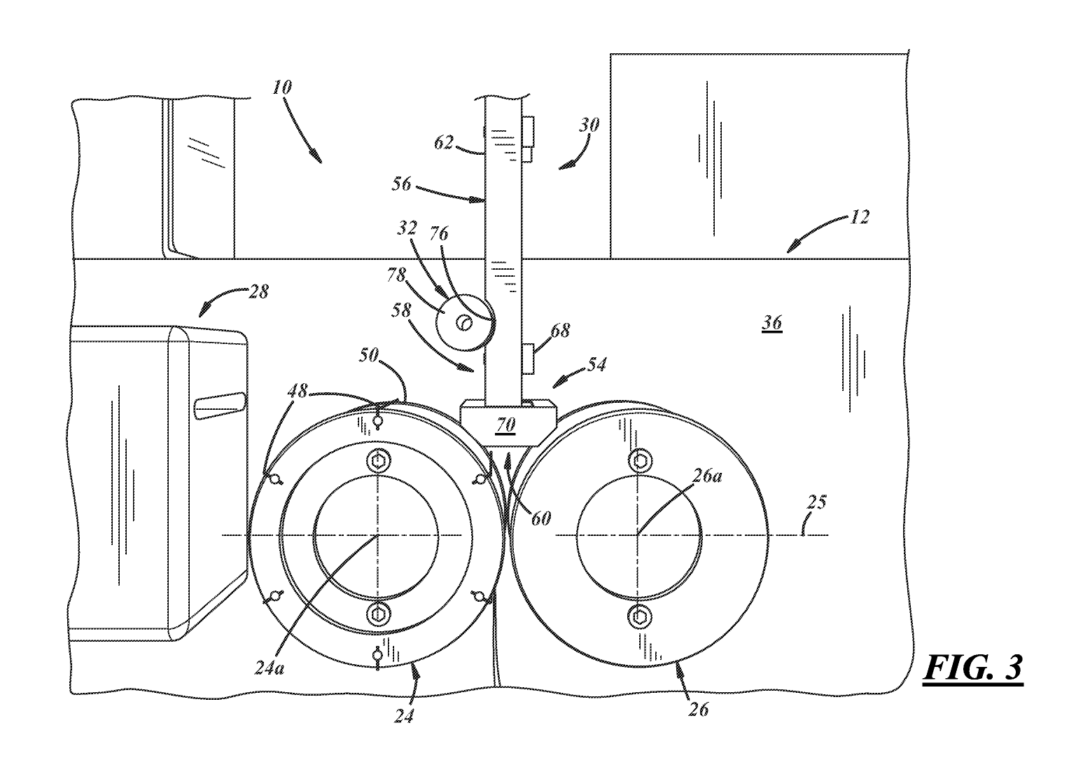

With reference to FIG. 3, the pill guide 30 also includes a guide path 56 between the upstream and downstream ends 52, 54, and an ejection path 58 and having an ejection outlet 60 at the downstream end 54 of the pill guide 30 and spaced apart from the line of contact between the first and second sheets 18, 20 of the cover material between the package rollers 24, 26. The outlet 60 may be spaced from the line of contact according to a distance that is less than one half of the diameter of the rollers 24, 26. But such spacing may be varied for optimal packaging performance. Accordingly, the pill guide 30 can be made shorter or longer depending on the application.

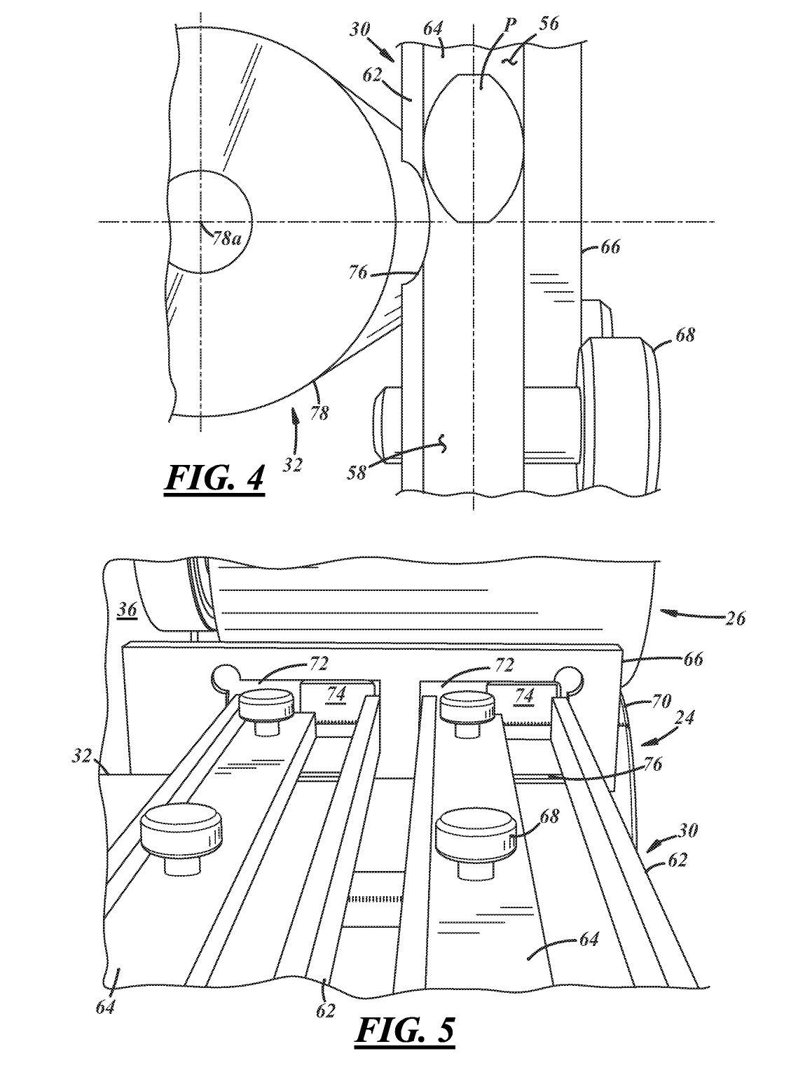

Also with reference to FIG. 4, the guide and ejection paths 56, 58 may be considered to be longitudinally overlapped, spaced apart, or contiguous. Also, the guide and ejection paths 56, 58 need not be laterally offset from one another and, in fact, may extend along a common longitudinal axis, although it is contemplated that the guide path 56 could be disposed at an angle with respect to the ejection path 58. In the illustrated embodiment of FIG. 4, the common axis may be substantially perpendicular, for example within plus or minus ten degrees, to the axis 25 extending through both of the rotational axes 24a, 26a of the first and second package rollers 24, 26. The guide path 56 and/or the ejection path 58 are preferably straight just upstream and downstream of the pill ejector 32.

With reference to FIG. 5, the pill guide 30 may be constructed from a track, which may include a U-shaped open rail 62, a spacer strip 64 carried in the rail 62, a cover 66 over the spacer strip 64 and rail 62, and fasteners 68 to fasten the cover 66 and the spacer strip 64 to the rail 62. Accordingly, the cover 66, spacer strip 64, and rail 62 may cooperate to define a longitudinal channel through which pills may flow. Also, the pill guide 30 may include an outlet member 70 at the downstream end 54, wherein the outlet member 70 may be fastened or otherwise coupled to the support member 36 and engaged to and supporting the end of the track. For example, the outlet member 70 may include pockets 72 to receive the end of the track, and outlet openings 74 to communicate the pills from the track to a location between the rollers 24, 26. The pill guide 30 may include an opening 76 through which a portion of the pill ejector 32 may extend into the guide and ejection paths 56, 58.

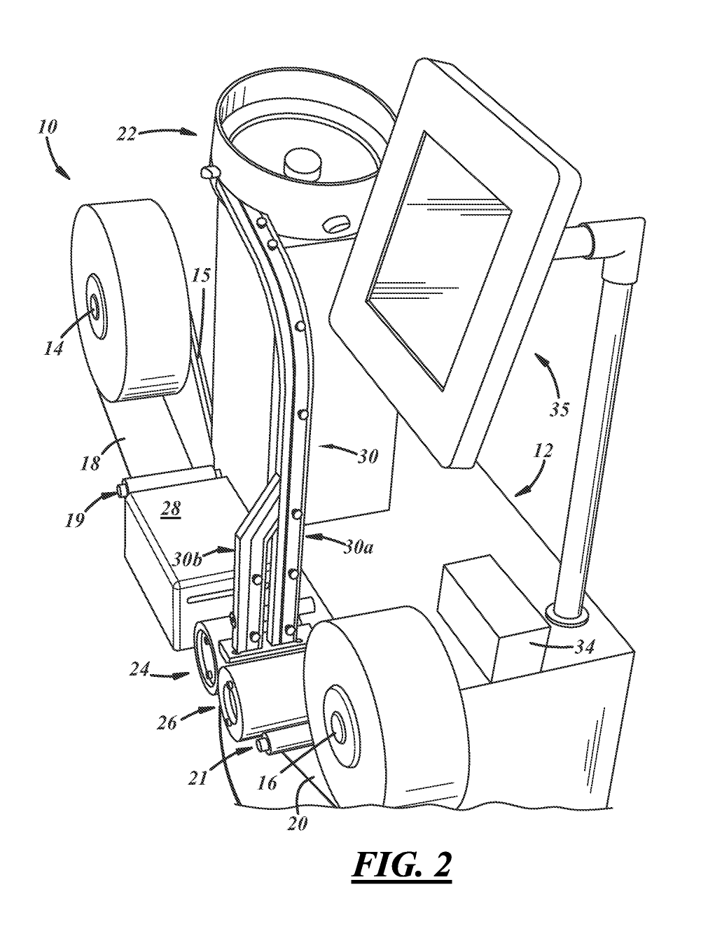

In the illustrated embodiment shown in FIG. 4, the opening 76 may include an aperture in a base of the rail 62 and a relief in the spacer strip 64 that correspond to a portion of the pill ejector 32. Also, with reference to FIG. 2, the pill guide 30 may be branched to include a main portion 30a, and a branch portion 30b branched from the main portion 30a for supplying an additional row of pills to the package rollers 24, 26. Those of ordinary skill in the art will recognize that the pill guide 30 may include one pill guide path or any other suitable quantity of pill guide paths, branches, roller pocket rows, and the like to produce two or more parallel rows of packing strips, and that the pill guide 30 may be constructed in any other suitable manner.

Referring to FIGS. 3 and 4, the pill ejector 32 may include a resiliently deformable ejection roller 78 oriented between the guide and ejection paths 56, 58 and having an outer diameter to frictionally contact pills and eject the pills through the ejection path 58 out of the ejection outlet 60 (FIG. 3) to a location between the first and second sheets 18, 20 of cover materials. The outer diameter of the roller 78 may interrupt or intersect the width of the channel of the pill guide 30 through which the pills travel such that there is a narrowing of the channel of the pill guide 30 by the roller 78. However, the roller 78 is at least somewhat resiliently deformable to allow the pills to pass between roller 78 and the cover 66, while frictionally rotationally contacting the pills. The guide path 56 and/or the ejection path 58 are preferably straight just upstream and downstream of the roller 78. The ejection roller 78 may initially contact a pill P while it is in the guide path 56, move the pill out of the guide path 56 toward the ejection path 58, and eject the pill through the ejection path 58 toward the outlet 60. The ejection roller 78 may be composed of a material having a durometer of 30 to 60 on the Shore A scale (ASTM D2240), or of a material having a durometer of 20 to 60 on the Shore 00 scale (ASTM D2240). For example, the ejection roller may 78 be composed of NEOPRENE, soft plastic, sponge, or gel material, or of any other material(s) suitable for resiliently deforming yet frictionally engaging and ejecting the pills out of the pill guide 30.

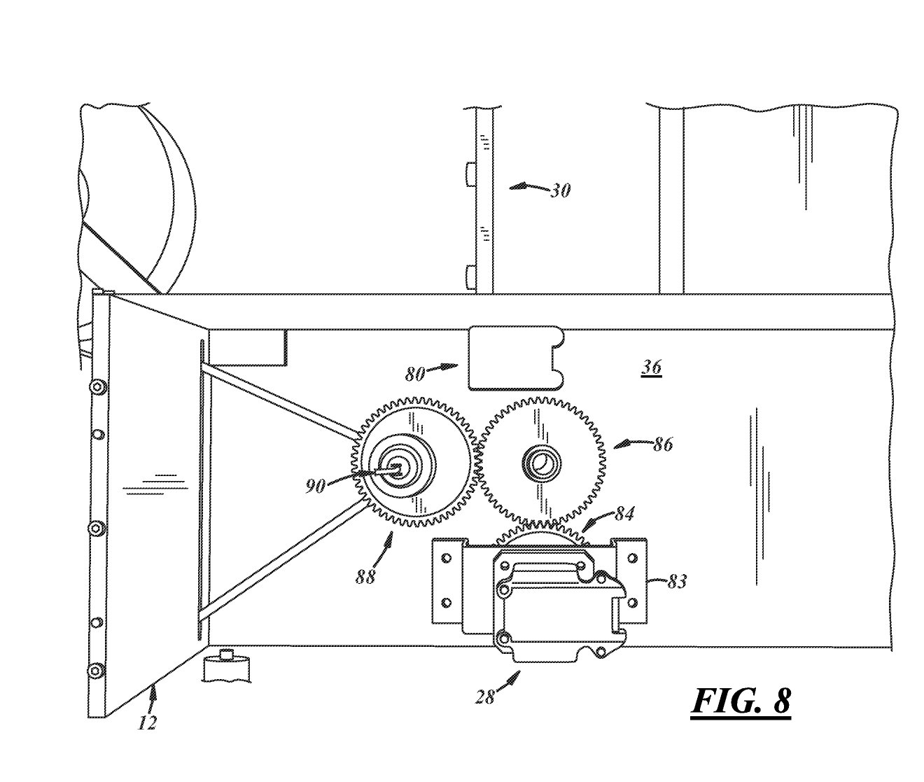

Referring now to FIGS. 7 and 8, the pill ejector 32 may include a motor 80 that may be carried by the support member 36 of the machine support 12, a motor output shaft (not shown), and the ejection roller 78 coupled to the output shaft. The motor 80 may include a stepper and/or servo motor, for example, an M drive 17 by Schneider. The motor 80 may include a velocity and/or position sensor integrated therewith. With reference to FIG. 7, the ejection roller 78 may be cylindrical and may have a rotational axis 78a that extends parallel with respect to the rotational axes 24a, 26a of the package rollers 24, 26.

Also, with reference to FIGS. 7 and 8, the machine 10 may include a roller powertrain, which may include a roller drive motor 82 that may be carried by the support member 36, for example, via a bracket 83 or in any other suitable manner. The roller drive motor 82 may have an output shaft (not shown) coupled in any suitable manner to a drive gear 84 (FIG. 8), which, in turn, may be enmeshed with a first driven gear 86, which, in turn may be enmeshed with a second driven gear 88. The first and second driven gears 86, 88 of the powertrain may be coupled, respectively to the first and second package rollers 24, 26 (FIG. 7). Those of ordinary skill in the art will recognize that any other type of roller powertrain may be used, including belts, chains, or the like. In any case, the roller drive motor 82 may include a stepper and/or servo motor, for example, and M drive 23 by Schneider. The motor 82 may include a velocity and/or position sensor integrated therewith.

Further, with reference to FIG. 7, the machine 10 may include a roller heater 90 that may extend through the second driven gear 88, through the bearing supports 40, 41 and the support member 36, and into the second roller 26, which may be a thermal roller to heat the cover material(s) for heat sealing the cover materials together. The roller heater 90 may include a rotary coupling, for example, a model 430 from Mercota, and also may include, a roller heater, for example, a K1111-41 model from Temco.

Additionally, in the illustrated embodiment, the machine 10 may include a clutch 92 to advance and retract the second roller 26 into and out of operational position, to prevent heated roller from burning the packaging material or the other roller. In another embodiment, the machine 10 instead may include a solenoid interposed between the roller 26 and a fixed portion of the machine to advance and retract the roller 26. In the latter embodiment, a linear velocity displacement transducer also may be incorporated to provide positional feedback for advancing and retracting the roller 26.

Referring now to FIG. 9, the machine 10 includes a control system 100 which may include the computer 34 including the user interface 35, a motor for the pill feeder 22, the printer 28, the roller drive motor 82, the pill ejector motor 80, and the heater 90. The computer 34 may be used to carry out various aspects of the presently disclosed method. In one example, the computer 34 may receive input data and instructions from a user via the user interface 35, process the received input in light of stored software and/or data, and transmit output signals to the various machine elements. Conversely, in another example, the computer 34 may receive input signals from the various machine elements, process the received input signals in light of stored data and software, and transmit output data to the user via the user interface 35.

The computer 34 generally may include memory 102, a processor 104 coupled to the memory 102, and one or more interfaces 106 coupled to the processor to communicate signals between the processor 104 and the various system input and/or output devices. Of course, the computer further may include any ancillary devices, for example, clocks, internal power supplies, and the like (not shown). Although not shown, the computer may be supplied with electricity by an external power supply, for example, an AC to DC transformer, one or more batteries, fuel cells, and the like. In one example, the computer 34 may include an iMX6 platform available from Freescale. The computer 34 may be networked over an intranet or the Internet to a pharmacy computer.

The interfaces 106 may include internal and/or external communication interfaces and may include wired and/or wireless devices. For example, the interfaces 106 may include an internal bus, which may provide for data communication between the processor 104, memory 102, and/or other interface elements of the computer 34. In another example, the interfaces 106 may include an external bus for data communication between elements of the computer 34 and the various system input and/or output devices. The interfaces 106 may include one or more of any of several types of bus structures, including a memory bus or memory controller, a peripheral bus, an accelerated graphics port, a local or processor bus, and using any of a variety of bus architectures. Also, the interfaces may include analog-to-digital or digital-to-analog converters, signal conditioners, amplifiers, filters, other electronic devices or software modules, and/or any other suitable interfaces. The interfaces 106 may conform to, for example, RS-232, parallel, small computer system interface, universal serial bus, and/or any other suitable protocol(s). The interfaces 106 may include circuits, software, firmware, and/or any other device to assist or enable the computer in communicating internally and/or externally with other devices.

The processor 104 may process data and execute instructions that provide at least some of the functionality for the packaging machine 10. As used herein, the term instructions may include, for example, control logic, computer software and/or firmware, programmable instructions, or other suitable instructions. The processor 104 may include, for example, one or more microprocessors, microcontrollers, discrete logic circuits having logic gates for implementing logic functions on data signals, application specific integrated circuits with suitable logic gates, programmable or complex programmable logic devices, programmable or field programmable gate arrays, and/or any other suitable type of electronic processing device(s).

The memory 102 may include any computer readable medium or media configured to provide at least temporary storage of at least some data, data structures, an operating system, application programs, program modules or data, and/or other computer software or computer-readable instructions that provide at least some of the functionality of the system and that may be executed by the processor. The data, instructions, and the like may be stored, for example, as look-up tables, formulas, algorithms, maps, models, and/or any other suitable format. The memory 102 may be in the form of removable and/or non-removable, volatile memory and/or non-volatile memory. Illustrative volatile memory may include, for example, random access memory (RAM), static RAM (SRAM), dynamic RAM (DRAM) including synchronous or asynchronous DRAM, and/or the like, for running software and data on the processor. By way of example, and not limitation, the volatile memory may include an operating system, application programs, other memory modules, and data. Illustrative non-volatile memory may include, for example, read only memory (ROM), erasable programmable ROM (EPROM), electrically erasable programmable ROM (EEPROM), dynamic read/write memory like magnetic or optical disks or tapes, and static read/write memory like flash memory, for storing software and data. Although not separately shown, the computer 34 may also include other removable/non-removable volatile/non-volatile data storage or media. For example, the other media may include dynamic or static external storage read/write device(s).

The methods or parts thereof can be implemented in a computer program product including instructions carried on a computer readable medium for use by one or more processors of one or more computers to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program product can be executed on one computer or on multiple computers in communication with one another.

The program(s) can be embodied on non-transitory computer readable media, which can include one or more storage devices, articles of manufacture, or the like. Example non-transitory computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The non-transitory computer readable medium may also include computer to computer connections, for example, via a network or another communications connection (either wired, wireless, or a combination thereof). Non-transitory computer readable media include all computer readable media, with the sole exception of transitory propagating signals. Any combination(s) of the above examples is also included within the scope of the computer-readable media. It is therefore to be understood that the method(s) can be at least partially performed by any electronic articles and/or devices capable of executing instructions corresponding to one or more steps of the disclosed method(s).

It is therefore to be understood that the method may be at least partially performed by any electronic articles and/or devices capable of executing instructions corresponding to one or more steps of the disclosed method.

In operation, and with reference to FIG. 1, an operator may manually load the spindles 14, 16 with cover materials, and feed the first and second sheets 18, 20 of cover materials against first and second guide rollers 19, 21 and toward and partially around the first and second package rollers 24, 26. Of course, the operator may feed the first sheet 18 of cover material into, through, and out of the printer 28, between the first guide roller 19 and the first package roller 24. Also, the operator may fill the pill feeder 22 with pills, activate the pill feeder 22 to fill the pill guide 30, and then activate the rest of the machine 10 to begin packaging the pills.

Accordingly, the first and second sheets 18, 20 of packaging cover materials are supplied, and rolled into spaced apart opposed relation and into contact with one another. The pills are guided along the guide path 56 toward the ejection path 58. The pills may fall under the force of gravity along the pill guide track, or the pills may fall faster, for example, under the output force of the pill feeder at rate of 10 to 20 pills per second. Accordingly, the feed rate of the pills to the ejection roller 78 from the pill feeder may be the same as or greater than the output feed rate of the pills from the ejection roller 78.

Referring to FIG. 3, the ejection roller 78 is spun into frictional contact with a pill to eject the pill through the ejection path 58 out of the ejection outlet 60 to a location between the first and second sheets 18, 20 between the roller 24, 26. For example, the motor-powered roller 78 may be used to shoot or launch the pill through an air gap between the ejection outlet 60 and the first and second sheets 18, 20 of cover materials. The first and second sheets 18, 20 are further rolled to enclose the pill therebetween. During rolling of the sheets 18, 20, heat may be applied to at least one of the first and second sheets 18, 20 via the heated package roller 26 to heat seal the first and second sheets 18, 20 together and thereby produce a thermally laminated sheet pill package. More specifically, the sheet rolling may include bringing opposing surfaces of the first and second sheets 18, 20 together in such a manner so as to extend laterally and longitudinally beyond the pills, and then heat sealing margin or seam portions of the first and second sheets 18, 20 along longitudinal seam portions laterally outboard of the pills and along transverse seam portions longitudinally between the pills, and perforating the first and second sheets 18, 20 along the transverse seam portions to define individual pill packages that are removable from the packaging strip. The rotational speed of the ejection roller 78 may be synchronized or set to correspond with the rotational speed of the packaging rollers 24, 26. Also, or instead, the ejection roller 78 may be provided in different diametric sizes so that the pill ejection rate is synchronized or set to correspond with the rotational speed of the packaging rollers 24, 26.

Accordingly, and with reference to FIGS. 10 and 11, the method may be used to produce a strip 200 of laminate sheet pill packages 202 that may be separated by perforation lines 204. As shown in FIG. 10, each package 202 may include a base cover 206 that may include printing on an outer surface 208 thereof, a second cover 210 that may be transparent, and pills P sealed between the covers. As shown in FIG. 11, two side by side strips 200a, 200b may be produced and may be separated by cutting from the roller knife.

During automatic operation, the process may be continuous in that the package rollers 24, 26 and/or the ejection roller 78 rotate continuously, and not incrementally in a stop-and-go manner. In other words, the process need not include circumferential indexing of the rollers 24, 26 and/or 78 when creating each pill package. The computer 34 may coordinate the output feed rate of the pill feeder with the output feed rate of the pill ejector to ensure that the pill ejector is continuously fed with a supply of pills to be ejected. Likewise, the computer 34 simultaneously may coordinate the rotational speed of the rollers 24, 26 so that the pill ejector ejects one pill into every individual pill packet 202. During development of the process, it was discovered that the printer 28 is the constraint to throughput of the machine 10. Without the printer 28 the process can run at about 20 pills per second, but is limited to about 10 pills per second with the printer 28. Accordingly, the computer 34 can coordinate the feed rates and the roller rotation rates in accordance with the printer feed rate.

Referring again to FIG. 1, the machine 10 also may include a package outlet guide 94 downstream of the rollers 24, 26 to guide the finished package strip away from the rollers 24, 26 and to any suitable downstream location. Also, the machine 10 may include a camera 96 downstream of the rollers 24, 26 to verify presence of one or more pills in each individual package of the finished package strip. The camera 96 may be in communication with the computer 34. The computer 34 may run any suitable machine vision software to verify presence of pills and, upon, identifying an undesired absence of a pill in any given packet, the computer 34 may stop the machine 10 in any suitable manner, issue any suitable alert, or the like.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “said” are intended to mean that there are one or more of the elements. Moreover, directional words such as front, rear, top, bottom, upper, lower, radial, circumferential, axial, lateral, longitudinal, vertical, horizontal, transverse, and/or the like are employed by way of description and not limitation. Other terms are to be construed using their broadest reasonable meaning unless they are used in a context that requires a different interpretation.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

What is claimed is:

1. A pill packaging machine comprising:
first and second spindles to carry coils of first and second sheets of flaccid packaging material;
first and second package rollers to feed the first and second sheets into spaced apart opposed relation to one another, wherein the package rollers have rotational axes;
a pill guide including:
an upstream end,
a downstream end located between the rotational axes of the package rollers and spaced upstream from a line of contact between the first and second sheets,
a guide path between the upstream and downstream ends, and
an ejection path having an ejection outlet at the downstream end of the pill guide; and
an ejector oriented between the guide and ejection paths to eject the pills at a controlled velocity in excess of that provided by gravity free fall alone and including a resiliently deformable ejection roller having an outer diameter to frictionally contact the pills and eject the pills through the ejection path out of the ejection outlet to a location between the first and second sheets.

2. The packaging machine of claim 1, wherein the guide and ejection paths are not laterally offset from one another.

3. The packaging machine of claim 2, wherein the guide and ejection paths extend along a common axis.

4. The packaging machine of claim 3, wherein the common axis is substantially perpendicular to an axis extending through both of the rotational axes of the first and second package rollers.

5. The packaging machine of claim 1, wherein the pill guide includes a track having an opening through which a portion of the ejection roller extends into the guide and ejection paths.

6. The packaging machine of claim 1, wherein the pills are guided along the guide path edge-first.

7. The packaging machine of claim 1, wherein the ejection roller is composed of NEOPRENE.

8. The packaging machine of claim 1, further comprising a bowl feeder having an outlet in communication with an upstream end of the pill guide, wherein the bowl feeder has an operational axis disposed at an angle of greater than one degree from horizontal.

9. The packaging machine of claim 8, wherein the operational axis is disposed at an angle of ten to twenty degrees from horizontal.

10. The packaging machine of claim 1, wherein the guide and ejection paths are straight upstream and downstream of the ejection roller.

11. The packaging machine of claim 1, wherein the guide and ejection paths extend along a common longitudinal axis or the guide path is disposed at an angle with respect to the ejection path.

12. The packaging machine of claim 1, further comprising a bowl feeder having an outlet in communication with an upstream end of the pill guide, wherein the bowl feeder feeds the pills to the ejection roller at a speed greater than that provided by gravity free fall alone.

13. The packaging machine of claim 12, wherein the bowl feeder and the ejector operate at a rate of ten to twenty pills per second.

14. A method of packaging pills comprising the steps of:
supplying first and second sheets of flaccid packaging material;
rolling the first and second sheets into spaced apart opposed relation and into contact with one another;
guiding pills along a guide path toward an ejection path having an ejection outlet that is spaced apart from a line of contact between the first and second sheets;
spinning a resiliently deformable ejection roller into frictional contact with the pills to eject the pills through the ejection path out of the ejection outlet to a location between the first and second sheets; and
further rolling the first and second sheets to enclose the pills therebetween.

15. The method of claim 14, wherein guiding step includes allowing the pills to fall under the force of gravity along a track having a discharge end through which the pills are ejected.

16. The method of claim 15, wherein the spinning step includes launching the pills through an air gap between the ejection outlet and the first and second sheets.

17. The method of claim 14, wherein the rolling steps include applying heat to at least one of the first and second sheets via a heated roller to heat seal the first and second sheets together and thereby produce a laminated sheet pill package.

18. The method of claim 14, wherein the rolling steps include:
bringing opposing surfaces of the first and second sheets together to extend laterally and longitudinally beyond the pills,
heat sealing seam portions of the first and second sheets along longitudinal seam portions laterally outboard of the pills and along transverse seam portions longitudinally between the pills, and
perforating the first and second sheets along the transverse seam portions to define individual pill packages.

19. A pill package produced by the method of claim 14.

20. The method of claim 14, wherein the guide and ejection paths are not laterally offset from one another.

21. The method of claim 20, wherein the guide and ejection paths extend along a common longitudinal axis or the guide path is disposed at an angle with respect to the ejection path.

22. The method of claim 14, wherein the pills are guided along the guide path edge-first.

23. The method of claim 14, further comprising the step of feeding the pills to the ejection roller at a speed greater than that provided by gravity free fall alone.

24. The method of claim 23, wherein the feeding step and spinning step are carried out at a rate of ten to twenty pills per second.

25. The method of claim 14, wherein the guide and ejection paths are straight upstream and downstream of the ejection roller.
